(19) United States
(12) Patent Application Publication
(10) Pub. No.: US 2012/0152634 A1
(43) Pub. Date: Jun. 21, 2012

(54) Electricity generating in a vehicle by way of a fifth wheel

(76) Inventor: Matthew Skis, Bonita Springs, FL (US)

(21) Appl. No.: 12/928,787

(22) Filed: Dec. 20, 2010

(51) Int. Cl. B60K 25/08

(52) U.S. Cl. 180/165; 180/65.21; 903/903

(57) ABSTRACT

The inventive concept is directed fifth wheel assembly having a tire thereon that makes contact with the ground the vehicle is traveling on. The fifth wheel is in driving contact with a generator located on said fifth wheel assembly to produce an electric current that is fed by way of a computer controlled system to a battery located on the vehicle. The frame assembly that supports the fifth wheel is hinged in a predetermined location on the vehicle and has a biasing system that biasses the fifth wheel downwardly to assure a continued contact of the fifth wheel with the ground the vehicle is traveling on. The fifth wheel can be mounted on various locations on the vehicle and under it and behind it. When behind the vehicle, the fifth wheel can be mounted on a small trailer which is pulled by a hitch on the vehicle. When mounted under the vehicle, the panel of the vehicle could be modified with an upwardly directed well to receive the tire when not in use.

### BACKGROUND OF THE INVENTION

In this day and age with millions of automobiles on road by way of passenger cars, trucks, busses and various other vehicles being driven by way of an internal combustion engine. It has been established for a long time already that these combustion engines contribute to general air pollutions. Also the supply of fossil fuel is not available after an uncertain period of time. Therefore, attempts are being made to convert passenger cars to be driven by electricity. These attempts have resulted in so called hybrid vehicles which are using a combination of energy resulting from the fossil fuel and electricity. One such attempt is an electrically powered vehicle that is recharged and self-energized during travel by apparatus interconnecting drive or driven wheels with generators. However, these drive wheels cause the vehicle to travel over the road surface at the time as they are driving some kind of a generator. A battery system is recharged by the generator units responsive to a controller. At some known installations, back-up systems are recharging the battery system by way of photoelectric or solar electrical panels and/or electromagnetic-induction charging levers. On onboard computerized controller regulates the flow of the generated current to the battery system and the flow of stored current to the motor units.

### BRIEF DESCRIPTION OF THE INVENTION

The above noted charging systems are the result of a specially constructed vehicle. An object of the inventive concept is that any present vehicle can be equipped with electricity generating units as an after thought or by adding additional generating units, as a retrofit, without having to reconstruct the vehicle to a great extent. The inventive concept consists of the use of fifth wheel that will be driven by the road surface. The fifth wheel may be constructed as a trailer unit that can be attached to an existing hitch behind the vehicle or it is easy to install a hitch. The unit may consist of a frame member that has attached to the end thereof a regular tire with a pulley thereon and the frame member also carries a generator that has a pulley thereon which is driven by way a belt thereon from the pulley of the tire shaft. The frame member may also carry a battery that is being charged from the generator by a computerized controller. The battery may be in the trunk of the vehicle together with a controller or any other preferred location. The frame member holds the tire in contact with the road surface because of its own weight or by an additional tension device such as springs or a hydraulic cylinder.

Another way of supporting a fifth wheel on the vehicle could be achieved by way of the undercarriage of the vehicle. This would be a more involved installation but, nevertheless, does not involve any major constructions to the vehicle. The frame of the fifth wheel could be mounted on one of frame members of the vehicle. A spring device could be used to cause the fifth wheel frame to be held in contact with the road surface, of course, by way of a tire running on the road surface. There would by a pulley on the wheel drive shaft that could drive a pulley on a generator at a remote location. The simplest approach would be to attach the generator directly to drive shaft of the tire by way of a direct drive. The fifth wheel frame member could be held in a downward contact position by way of a spring assembly mounted on a hinge or a pivot that mounts the frame member to the undercarriage of the vehicle. It can be assumed that the fifth wheel frame can be mounted anywhere under the vehicle wherever desired. In a more sophisticated installation, the bottom of the lowest metal panel of the vehicle could be modified to provide an upwardly facing well to receive the tire therein when the frame member is deactivated.

### BRIEF DESCRIPTION OF THE DRAWING

FIG. 1 is an illustration of the basic concept of the invention indicating where different locations can be used on the vehicle and where to mount the fifth wheel;

FIG. 2 shows one example where the fifth wheels is on a small trailer hitched to a vehicle;

FIG. 3 is a rear view of a fifth wheel mounted close to a tire;

FIG. 4 is a side view of the fifth wheel of FIG. 3

FIG. 5 is a rear view of FIG. 5 including a showing of a spring assembly.

### DETAILED DESCRIPTION OF THE INVENTION

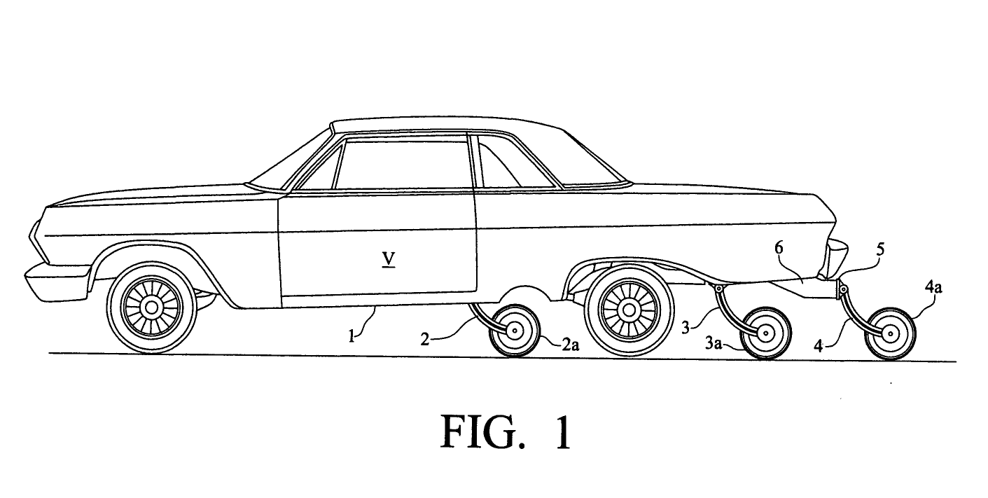

FIG. 1 is a side view of the vehicle V showing possible installation locations of the bottom 1 of the vehicle for the fifth wheel. There is a frame member 2 mounted almost midway of the vehicle V. The frame member 2 carries a tire 2a. In this location it would be advisable to provide an upwardly directed well in the bottom panel or plate, the well is shown just above the wheel 2a. This could be accomplished by providing a hump behind the back of the front seat. It would involve some construction changes but could easily be accomplished within the realm of the inventive concept. The frame member 3 in FIG. 1 can easily be mounted underneath the trunk area of the vehicle V including the tire 3a. The last suggestion could involve an installation behind the vehicle on the bumper or below the bumper by a special support bracket 6 which would receive the same hinge 5 to support the frame member 4 and the tire 4a in the same manner as are being used in the other first and second locations. In this structure or location it would be easy to disengage the fifth wheel from the road surface just be swinging it upwardly against the rear of the trunk lid.

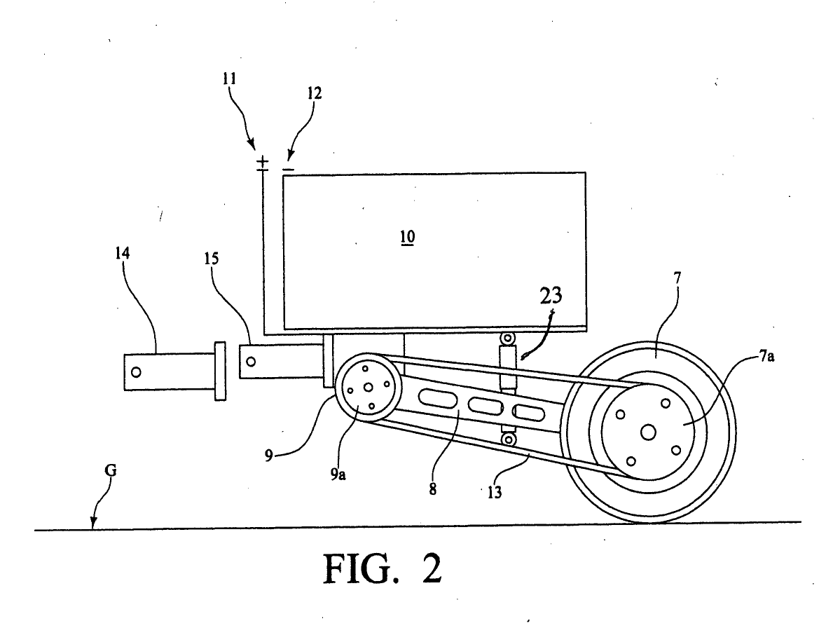

FIG. 2 illustrates an embodiment of the invention which requires no vehicle changes. The vehicle needs a hitch in the back which normally is used to tow trailers or boats. The FIG. 2 shows a trailer hitch 15 which connected to the vehicle 14. The hitch 15 has frame member 8 attached thereto which at its rear end has attached there a ground contacting tire which has thereto a pulley or gear wheel 7a. At the forward end of the frame member there is located a pulley or gear wheel 9a which attached thereto an electric generator 9. The pulley or gear wheel 7a drives the pulley or gear wheel 9a by way of a belt or chain, respectively. The frame member carries at its forward end a battery ten which delivers or receives electric current through the plus 11 or negative 12 lines. This direction of current is controlled by a computer controlled controller which is located somewhere in the vehicle. The tire 7 contacts the ground G on which the vehicle is traveling and downward pressure is applied to the frame member 8 by way of a hydraulic cylinder 23.

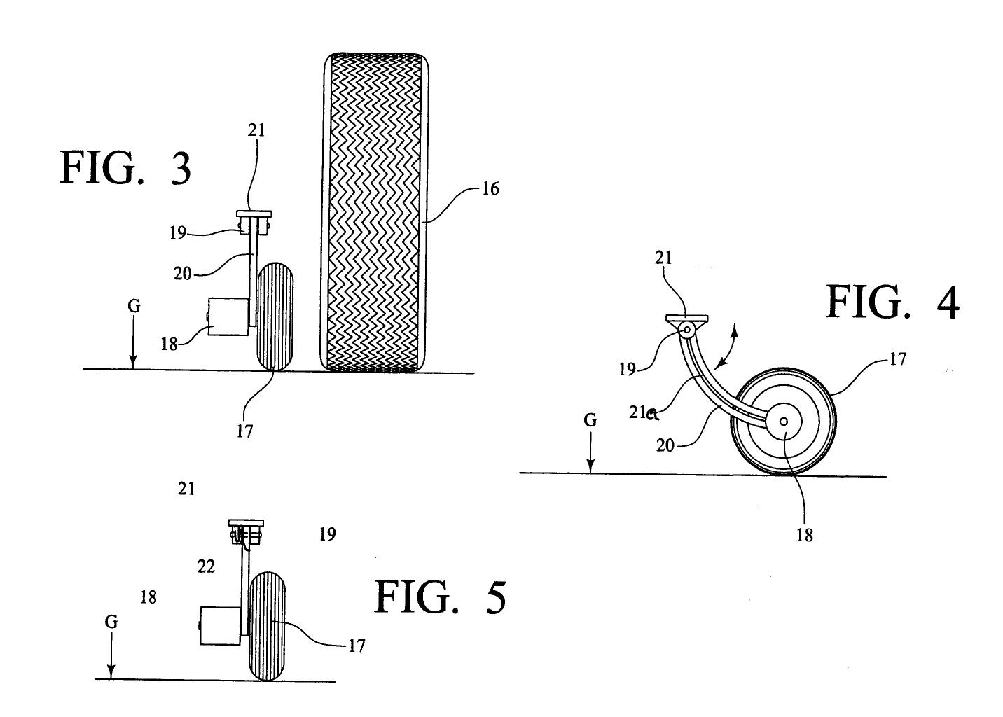

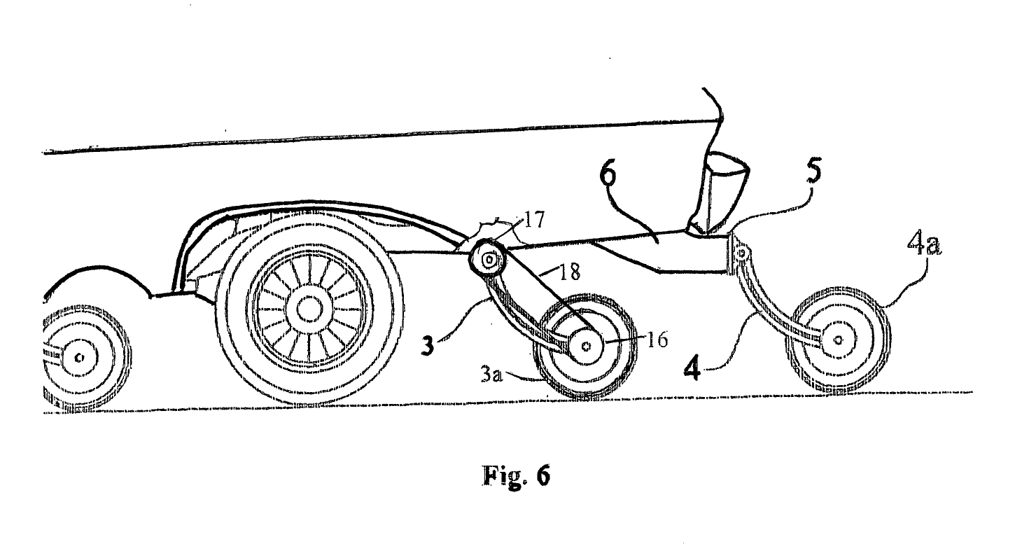

FIGS. 3 and 5 illustrate a rear view of the fifth wheel mounted on a support 21 on the bottom of the vehicle. The frame support 20 for the tire 17 running on the ground G is pivotal around a hinge 19 which is located on the vehicle support 21. The Figs. Also show the generator 18 which is in direct drive with the tire 17. FIG. 4 also shows a wiring system 21 a which is directly connected to the generator 18 and delivers the electric current directly to the computer controller located inside the vehicle and from there to the battery. FIG. 5 also illustrates, schematically, a coil spring 22 located in the hinge 19 and under the frame 21 to place a downward biasing force on the frame member 20 to keep the tire 17 in ground contact.

What I claim is:

1. A fifth wheel located on a vehicle to generate electrical energy for a battery located in said vehicle, said fifth wheel is mounted on said vehicle in such a manner to make contact with a ground said vehicle is traveling on, said fifth wheel driving a generator which is in driving connection with said fifth wheel, said generator producing an electric current to charge battery by way of controlled computer, including an upwardly directed well provided in a bottom panel of said vehicle to receive said vehicle wheel being pivoted upwardly when not in use.

2. The fifth wheel claim 1, wherein said fifth wheel is mounted under said vehicle.

3. The fifth wheel of claim 1, wherein said fifth wheel is located under the trunk area of said vehicle

4. (canceled)

5. (canceled)

6. The fifth wheel of claim 1, wherein said fifth wheel is a vehicle tire

7. (canceled)

8. The fifth wheel of claim 1, wherein said fifth wheel driving said generator is a pulley belt arrangement.

9. The fifth wheel of claim 1, wherein said fifth wheel driving said generator is a gear wheel chain arrangement.

10. The fifth wheel of claim 1, wherein said fifth wheel driving said generator is a direct drive arrangement.
